(19) United States
(12) Patent Application Publication
(10) Pub. No.: US 2019/0097803 A1
(43) Pub. Date: Mar. 28, 2019

(54) ENCRYPTED REVERSE BIOMETRIC TOKEN VALIDATION

(71) Applicant: Cubic Corporation, San Diego, CA (US)

(72) Inventors: Erik Vlugt, Poway, CA (US); Steffen Reymann, Guildford (GB); Niosha Kayhani, Sutton (GB)

(73) Assignee: Cubic Corporation, San Diego, CA (US)

(21) Appl. No.: 16/138,530

(22) Filed: Sep. 21, 2018

Related U.S. Application Data
(60) Provisional application No. 62/562,238, filed on Sep. 22, 2017.

(51) Int. Cl. H04L 9/32; H04L 9/08

(52) U.S. Cl. CPC H04L 9/3213; H04L 9/0866; H04L 9/3231

(57) ABSTRACT

Systems and methods of using data encryption to validate a biometric token within a transit system. One method includes sending, by a transit server, an encryption key to each of a biometric capture device and a portable electronic device. The method also includes capturing, by the biometric capture device, a biometric identifier of a transit user. The method further includes encrypting the captured biometric identifier using the encryption key, broadcasting a wireless signal containing the encrypted captured biometric identifier, and receiving a validation result indicating that the captured biometric identifier was matched to a registered biometric identifier by the portable electronic device. The method further include granting the transit user access to a restricted access area of the transit system based on the validation result.

### CROSS-REFERENCES TO RELATED APPLICATIONS

This application claims priority to U.S. Provisional Patent Application No. 62/562,238 filed Sep. 22, 2017 titled “REVERSE BIOMETRIC TOKEN VALIDATION,” the entire disclosure of which is hereby incorporated by reference, for all purposes, as if fully set forth herein.

### BACKGROUND OF THE INVENTION

As populations in the world's largest cities continue to grow, often at an exponential rate, public and private transportation systems are becoming increasingly burdened with increased ridership and transit stations are becoming increasingly congested, causing delays to transit users and increased costs to the transportation systems. The use of sophisticated communication devices presents an appealing approach for managing such overcrowding. Unfortunately, existing devices and approaches are insufficient to alleviate these problems. Accordingly, new systems, methods, and other techniques are needed.

### SUMMARY OF THE INVENTION

Examples given below provide a summary of the present invention. As used below, any reference to a series of examples is to be understood as a reference to each of those examples disjunctively (e.g., “Examples 1-4” is to be understood as “Examples 1, 2, 3, or 4”).

Example 1 is a method of using data encryption to validate a biometric token within a transit system, the method comprising: sending, by a transit server of the transit system, an encryption key to each of a biometric capture device and a portable electronic device; capturing, by the biometric capture device of the transit system, a biometric identifier of a transit user; encrypting, by the biometric capture device, the captured biometric identifier using the encryption key; broadcasting, by the transit system, a wireless signal containing the captured biometric identifier, wherein the wireless signal is received by the portable electronic device, and wherein the portable electronic device is configured to decrypt the captured biometric identifier using the encryption key; receiving, by the transit system from the portable electronic device, a validation result indicating that the captured biometric identifier was matched to a registered biometric identifier by the portable electronic device, wherein the registered biometric identifier was registered by the portable electronic device prior to capturing, by the biometric capture device, the biometric identifier of the transit user; and granting, by the transit system, the transit user access to a restricted access area of the transit system based on the validation result.

Example 2 is the method of example(s) 1, wherein the captured biometric identifier was matched to the registered biometric identifier by the portable electronic device by determining that a similarity score exceeded a similarity threshold.

Example 3 is the method of example(s) 1-2, wherein the wireless signal containing the captured biometric identifier is broadcasted without saving a copy of the captured biometric identifier within the transit system.

Example 4 is the method of example(s) 1-3, wherein the captured biometric identifier of the transit user includes one or more of: an image of the transit user; a video of a walking gait of the transit user; a fingerprint scan of the transit user; an eye scan of the transit user; a palm scan of the transit user; and a voice recording of the transit user.

Example 5 is a transit system for validating a biometric token, the transit system comprising: a biometric capture device configured to perform operations including: capturing a biometric identifier of a transit user; and broadcasting a wireless signal containing the captured biometric identifier, wherein the wireless signal is received by a portable electronic device; and an access control point configured to perform actions including: receiving, from the portable electronic device, a validation result indicating that the captured biometric identifier was matched to a registered biometric identifier by the portable electronic device, wherein the registered biometric identifier was registered by the portable electronic device prior to capturing, by the biometric capture device, the biometric identifier of the transit user; and granting the transit user access to a restricted access area of the transit system based on the validation result.

Example 6 is the transit system of example(s) 5, wherein the registered biometric identifier was registered using a mobile application downloaded onto the portable electronic device.

Example 7 is the transit system of example(s) 5-6, wherein the captured biometric identifier was matched to the registered biometric identifier by the portable electronic device by determining that a similarity score exceeded a similarity threshold.

Example 8 is the transit system of example(s) 5-7, wherein the wireless signal containing the captured biometric identifier is broadcasted without saving a copy of the captured biometric identifier within the transit system.

Example 9 is the transit system of example(s) 5-8, wherein the biometric capture device is not communicatively coupled to other components of the transit system.

Example 10 is the transit system of example(s) 5-9, further comprising: a transit server configured to send an encryption key to each of the biometric capture device and the portable electronic device, and wherein the operations further include encrypting the captured biometric identifier using the encryption key, wherein, after receiving the captured biometric identifier, the portable electronic device is configured to decrypt the captured biometric identifier using the encryption key.

Example 11 is the transit system of example(s) 5-10, further comprising: a transit server configured to receive a notification indicating that the registered biometric identifier was registered by the portable electronic device.

Example 12 is the transit system of example(s) 5-11, wherein the captured biometric identifier of the transit user includes one or more of: an image of the transit user; a video of a walking gait of the transit user; a fingerprint scan of the transit user; an eye scan of the transit user; a palm scan of the transit user; and a voice recording of the transit user.

Example 13 is a method of validating a biometric token within a transit system, the method comprising: capturing, by a biometric capture device of the transit system, a biometric identifier of a transit user; broadcasting, by the transit system, a wireless signal containing the captured biometric identifier, wherein the wireless signal is received by a portable electronic device; receiving, by the transit system from the portable electronic device, a validation result indicating that the captured biometric identifier was matched to a registered biometric identifier by the portable electronic device, wherein the registered biometric identifier was registered by the portable electronic device prior to capturing, by the biometric capture device, the biometric identifier of the transit user; and granting, by the transit system, the transit user access to a restricted access area of the transit system based on the validation result.

Example 14 is the method of example(s) 13, wherein the registered biometric identifier was registered using a mobile application downloaded onto the portable electronic device.

Example 15 is the method of example(s) 13-14, wherein the captured biometric identifier was matched to the registered biometric identifier by the portable electronic device by determining that a similarity score exceeded a similarity threshold.

Example 16 is the method of example(s) 13-15, wherein the wireless signal containing the captured biometric identifier is broadcasted without saving a copy of the captured biometric identifier within the transit system.

Example 17 is the method of example(s) 13-16, wherein broadcasting, by the transit system, the wireless signal includes broadcasting, by the biometric capture device, the wireless signal, and wherein the biometric capture device is not communicatively coupled to other components of the transit system.

Example 18 is the method of example(s) 13-17, further comprising: sending, by a transit server of the transit system, an encryption key to each of the biometric capture device and the portable electronic device; and prior to broadcasting the wireless signal, encrypting, by the biometric capture device, the captured biometric identifier using the encryption key, wherein, after receiving the captured biometric identifier, the portable electronic device is configured to decrypt the captured biometric identifier using the encryption key.

Example 19 is the method of example(s) 13-18, further comprising: prior to capturing the biometric identifier of the transit user, receiving, by a transit server of the transit system from the portable electronic device, a notification indicating that the registered biometric identifier was registered by the portable electronic device.

Example 20 is the method of example(s) 13-19, wherein the captured biometric identifier of the transit user includes one or more of: an image of the transit user; a video of a walking gait of the transit user; a fingerprint scan of the transit user; an eye scan of the transit user; a palm scan of the transit user; and a voice recording of the transit user.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates a block diagram of a transit system in communication with a portable electronic device, according to some embodiments of the present invention.

FIG. 2 illustrates a block diagram of a station system in communication with a portable electronic device, according to some embodiments of the present invention.

FIG. 3 illustrates an example of a transit location having various access control points, according to some embodiments of the present invention.

FIG. 4 illustrates a possible positioning of a wireless access point on the roof of a transit vehicle, according to some embodiments of the present invention.

FIG. 5 illustrates a block diagram of a station system including a biometric capture device, according to some embodiments of the present invention.

FIG. 6 illustrates a method of validating a biometric token within a transit system, accordingly to some embodiments of the present invention.

FIG. 7 illustrates a method of validating a biometric token within a transit system using data encryption, accordingly to some embodiments of the present invention.

FIG. 8 illustrates a method of validating a biometric token within a transit system using data encryption, according to some embodiments of the present invention.

FIG. 9 illustrates a method of validating a biometric token within a transit system using data encryption, according to some embodiments of the present invention.

FIG. 10 illustrates a method of validating a biometric token within a transit system using data encryption, according to some embodiments of the present invention.

FIG. 11 illustrates a simplified computer system, according to some embodiments of the present invention.

### DETAILED DESCRIPTION OF THE INVENTION

Embodiments of the present invention include systems, methods, and other techniques for using data encryption of biometric identifiers to securely grant transit access to transit users. Embodiments described herein solve the current problem in which hackers are able to access a transit device or a transit system and steal a transit user's registered biometric identifier. Storage of such biometric identifiers within the transit system is therefore problematic, which conventional systems view as an unavoidable risk. Embodiments described herein avoid any storage of biometric identifiers within the transit system and instead allow a transit user to register and store their biometric identifier on their own portable electronic device. After registration, the transit user may arrive at a transit location and a biometric capture device located therein may capture a biometric identifier of the user, encrypt the captured biometric identifier, and wirelessly broadcast the encrypted captured biometric identifier to nearby devices. The transit user's portable electronic device may receive and decrypt the encrypted captured biometric identifier and subsequently match it to the registered biometric identifier stored therein. The portable electronic device may then send a validation result indicating a successful match to a gate, which may grant access to the transit user.

Although embodiments of the present invention are described herein in reference to methods of validation in transit systems, a person of ordinary skill in the art will understand that alternative embodiments may vary from the embodiments discussed herein, and applications other than transit systems may exist (e.g., other ticketing applications (such as stadiums, museums, etc.), access control, etc.). Conventional techniques of validating biometric tokens (e.g., fingerprints, iris scans, palm prints, etc.) for access control or ticket validation usually match user data to a previously-stored referenced value in a local or remote database. This can include matching a scanned biometric token with information stored on a smart card that stores biometric reference data, and is inserted into a validator. These techniques have privacy issues about sharing personal biometric information and may have limited scalability when matching data against large database of biometric user data. In contrast, embodiments described herein have unlimited scalability because the matching between biometric identifiers that occurs on the user's device is a 1:1 matching instead of a 1:N matching.

Some embodiments of the present invention reverse the standard way of validating captured tokens against the reference in a database on the validation device (e.g., a gate, or validator in a transit system). The matching can take place on a personal device of the user (e.g., a mobile phone, tablet, or other electronic device with a secure element which holds the biometric information). The validation device only provides the reference sample, which is then validated against the user data on their personal device. The personal device conveys the outcome of the validation back to the validation device in a secure manner, allowing the validation device to, for example, open the gate in a transit system for the user. All communication between the validation device and the personal device can be connection-less, thereby fully preserving the anonymity and privacy of the user. Techniques make the communication channel secure and authenticatable by tokenizing interactions between devices. Additionally, overhead tracking (e.g., using a camera, and/or other sensor) can be used to ensure the correct user is identified in front of the validation device.

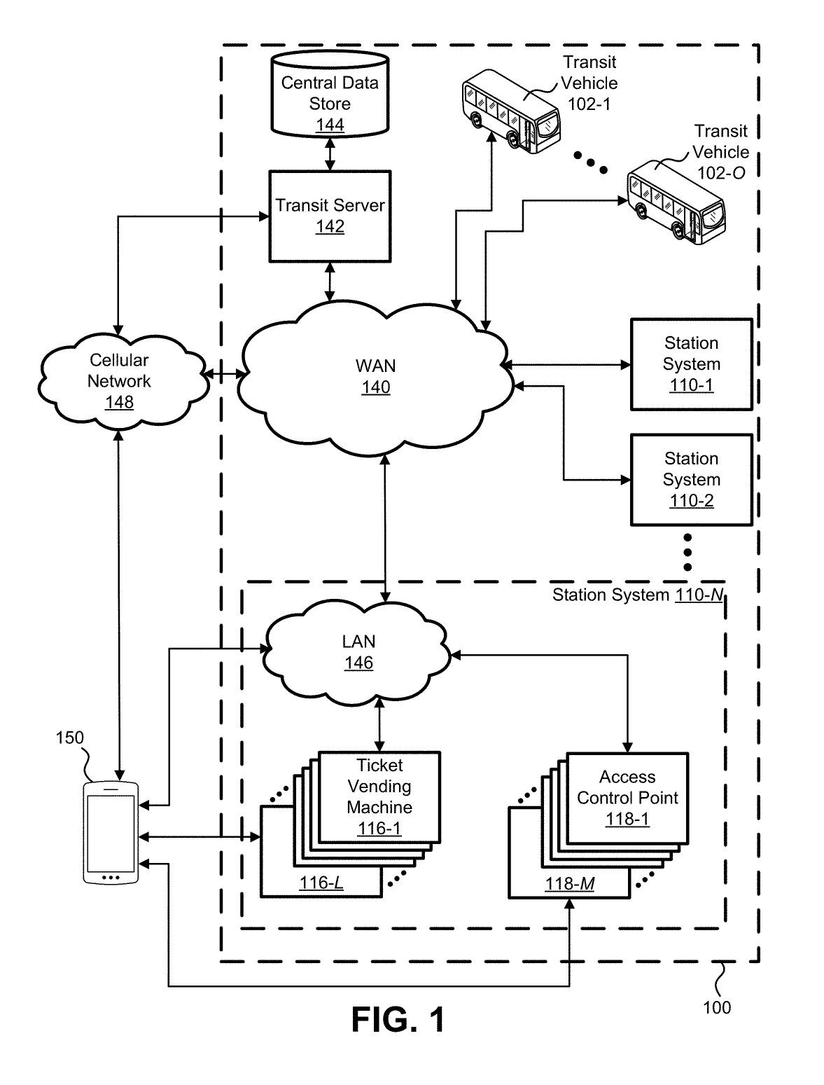

FIG. 1 illustrates a block diagram of a transit system 100 in communication with a portable electronic device 150, according to some embodiments of the present invention. Transit system 100 can include various forms of transit, including subway, bus, ferry, commuter rail, para-transit, etc., or any combination thereof. Transit system 100 may include a plurality of station systems 110 located at a plurality of transit locations (or simply “locations”) within transit system 100. While station systems 110 are generally considered to be fixed at transit locations, transit vehicles 102 move along predetermined routes often between different transit locations. For example, a transit user may begin a trip within transit system 100 at one of station systems 110 and may travel within one of transit vehicles 102 to another of station systems 110. Examples of transit vehicles 102 may include a train, a bus, a ferry, a plane, among other possibilities. Transit system 100 achieves interconnectivity between station systems 110, transit vehicles 102, and a transit server 142 via a wide area network (WAN) 140, which may include one or more wired and/or wireless connections. Devices within each of station systems 110 are locally interconnected via a local area network (LAN) 142, which may include one or more wired and/or wireless connections. Data used by transit server 142 in connection with operation of transit system 100 may be stored in a central data store 144 communicatively coupled to transit server 142.

Each of the transit locations may include a non-restricted access area and a restricted access area. The non-restricted access area may include areas that are freely accessible to the general public, whereas the restricted access area may be reserved exclusively for customers of transit system 100. Examples of a restricted access area may include: the inside of transit vehicles 102, a bus or train platform, the inside of a bus or train station, and the like. Each of station systems 110 may include various transit machines such as ticket vending machines 116 and access control points 118. Typically, each of ticket vending machines 116 is configured to allow a transit user to purchase a transit product such as train or bus ticket and each of access control points 118 corresponds to a location where a transit product is to be presented or is required to be in the transit user's possession. In some embodiments, each of access control points 118 includes an entry point to transit system 100 that defines a passageway and separates the non-restricted access area from the restricted access area. Examples of access control points 118 include a gate, a turnstile, a platform validator, an entrance/exit to transit vehicles 102, among other possibilities. Each of ticket vending machines 116 and access control points 118 may be communicatively coupled to LAN 146 via one or more wired and/or wireless connections.

In some embodiments, transit users may create and maintain a transit user account. The transit user account can comprise information regarding the transit user, such as a name, address, phone number, email address, user identification (such as a unique identifier of the user or other user ID), passcode (such as a password and/or personal identification number (PIN)), an identification code associated with a fare media used to identify a transit user and/or a transit user account, information regarding user preferences and user opt-in or opt-out selections for various services, product(s) associated with the transit user account, a value and/or credit associated with the product(s), information regarding a funding source for the transit user account, among other possibilities. A transit user may request a transit user account and provide the information listed above by phone (such as a call to a customer service center maintained and/or provided by transit system 100), on the Internet, at one of ticket vending machines 116, or by other means. Transit server 142 can use the information provided by the user to create the transit user account, which can be stored and/or maintained on a database, such as central data store 144.

In some embodiments, a funding source can be linked to a transit user account to provide funding to purchase transit products. The funding source can be external to transit system 100 and can be maintained by a financial institution. Such a funding source may include a savings or checking account, a prepaid account, a credit account, an e-commerce account (such as a PAYPAL® account), or more, which can transfer funds via automated clearing house (ACH) or other means. If a transit user account comprises information regarding a funding source, transit server 142 can use the information to fund purchases or other transactions of a transit user. These transactions can be made at station systems 110, transit vehicles 102, on the Internet, by phone, text, email, or a variety of other different ways, and transaction information can then be sent to transit server 142 to update the transit user account associated with the transactions and reconcile payments and purchases with the funding source. The transit server 142 can communicate with the financial institution (or other entity maintaining the funding source) through a financial network (not shown).

A transit user may interact with transit system 100 using a portable electronic device 150 communicatively coupled with various components of transit system 100. Portable electronic device 150 may be a smart phone or other mobile phone (including a near-field-communication (NFC)-enabled mobile phone), a tablet personal computer (PC), a personal digital assistant (PDA), an e-book reader, or other device. A communicative link from portable electronic device 150 to transit server 142 can be provided by a cellular network 148 in communication with WAN 140 or in direct communication with transit server 142. Portable electronic device 150 can thereby access and/or manage information of a transit user account. Furthermore, transit server 142 can send messages to portable electronic device 150 providing transit, account, and/or advertisement information to the transit user in possession of portable electronic device 150. Such messages may be based on, among other things, opt-in or opt-out selections and/or other user preferences as stored in a transit user account. A transit user can use portable electronic device 150 to download a transit application from transit server 142 or from a mobile application source. The mobile application source may be an application store or website provided by a mobile carrier or the hardware and/or software provider of portable electronic device 150.

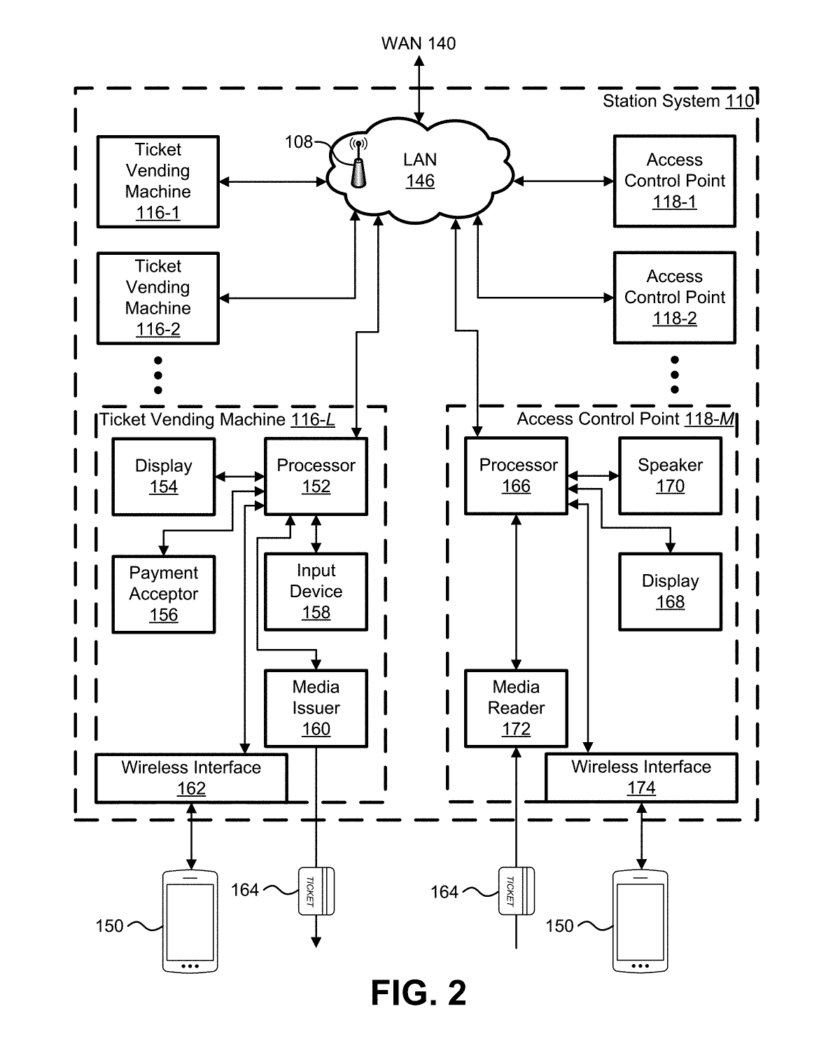

FIG. 2 illustrates a block diagram of station system 110 in communication with portable electronic device 150, according to some embodiments of the present invention. Any description provided herein in reference to components within station system 110 may also apply to components within transit vehicle 102, and vice-versa. For example, transit vehicle 102 may include any components described in reference to FIG. 2. Specific components of ticket vending machines 116 and access control points 118 may vary from the illustrated embodiment. In some instances, each of ticket vending machines 116 includes a processor 152 communicatively coupled with LAN 146. Processor 152 may include a single or multiple processors and an associated memory. Processor 152 may control a display 154 to display instructions for a transit user and/or a GUI through which the transit user may interact. Each of ticket vending machines 116 may further include a payment acceptor 156 for accepting cash, coin, or card-based payments, an input device 158 (such as a keypad) for receiving input from a transit user, and a media issuer 160 for dispensing a fare media 164 to the transit user. Media issuer 160 may include a printer for printing a new fare media 164 and/or a media reader/writer for adding additional value to an existing fare media 164. Each of ticket vending machines 116 may include a wireless interface 162 for enabling wireless communications between portable electronic device 150 and each of ticket vending machines 116.

In some instances, each of access control points 118 includes a processor 166 communicatively coupled with LAN 146. Processor 166 may include a single or multiple processors and an associated memory. Processor 166 may control a display 168 and a speaker 170 to provide visual and audible instructions for a transit user. Each of access control points 118 may include a media reader 172 for reading fare media 164 and, in conjunction with processor 166, for determining whether a transit user is permitted to access the non-restricted access area. Alternatively or additionally, media reader 172 may communicate with portable electronic device 150 to determine whether the transit user is permitted to access the non-restricted access area. Media reader 172 may include a contactless reader and/or a reader that requires contact with the object to be read. In some instances, media reader 172 includes a barcode reader and a barcode display. In some embodiments, display 168 and speaker 170 can give visual and audible instructions to the holder of portable electronic device 150 or fare media 164 that portable electronic device 150 or fare media 164 is not correctly placed to communicate with media reader 172. Each of access control points 118 may include a wireless interface 174 for enabling wireless communications between portable electronic device 150 and each of access control points 118. One of skill in the art will recognize that barriers associated with access control point 118 may open up to allow the holder of portable electronic device 150 or fare media 164 passage upon a successful communication between media reader 172 and portable electronic device 150 or fare media 164.

In some embodiments, wireless interfaces 162 and 174 may enable communication with portable electronic device 150 and fare media 164 by the transmission and reception of electromagnetic wireless signals. For example, devices may communicate using NFC, BLE, radio-frequency identification (RFID), and the like. In some embodiments, media reader 172 may include an RFID reader and fare media 164 may include an RFID tag. The RFID tag may be may be passive, active, or battery-assisted passive. In some embodiments, active RFID tags may be turned on and off by a user pressing a button on the RFID tag. Such embodiments may save power and preserve battery life.

In some embodiments, station system 110 may include a wireless access point 108 for providing connectivity to LAN 146 to a variety of devices within or near the transit location. For example, each of ticket vending machines 116 and access control points 118 may wirelessly connect to wireless access point 108. Portable electronic device 150 may be configured to automatically or manually connect to wireless access point 108 when the transit user holding the device is within the range of wireless access point 108.

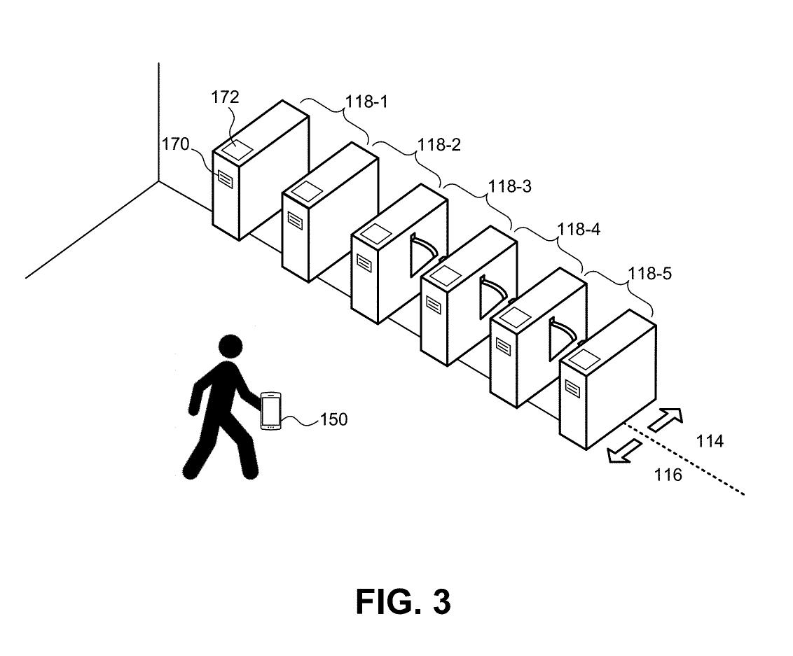

FIG. 3 illustrates an example of a transit location having various access control points 118, according to some embodiments of the present invention. Access control points 118 may include a plurality of gates separating a restricted access area 114 from a non-restricted access area 116. One or more of access control points 118 may be barrierless (i.e., “gateless”) (e.g., access control points 118-1 and 118-2) and one or more of access control points 118 may include barriers (e.g., access control points 118-3, 118-4, and 118-5). Each of access control points 118 may include media reader 172 positioned along one or both sides of the passageways formed by each of access control points 118. Each of access control points 118 may also include speaker 170 positioned near media reader 172 such that the holder of portable electronic device 150 may be near speaker 170 when a barcode displayed by portable electronic device 150 is read by media reader 172.

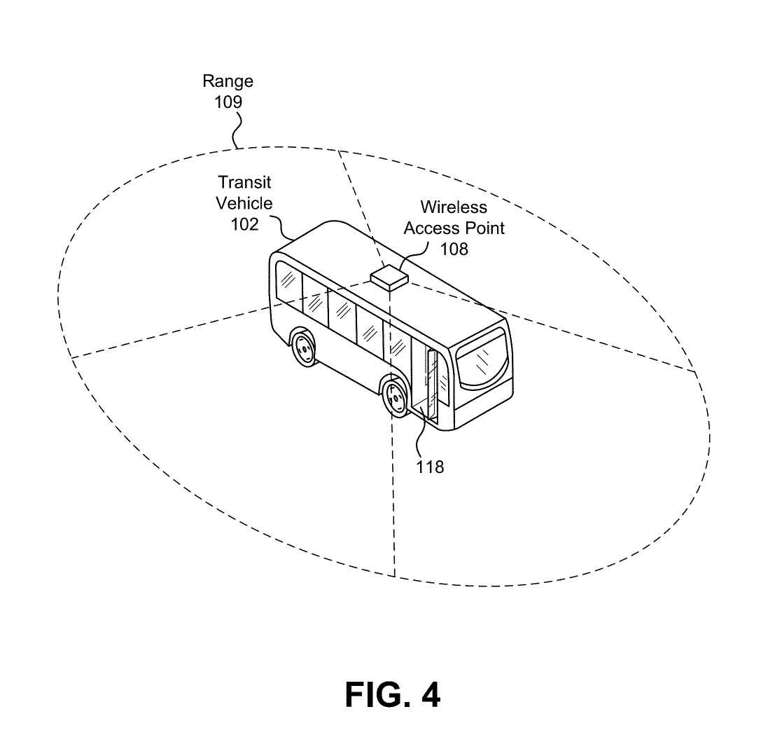

FIG. 4 illustrates a possible positioning of wireless access point 108 on the roof of transit vehicle 102, according to some embodiments of the present invention. Portable electronic device 150 may connect to LAN 138 upon entering a range 109 associated with wireless access point 108. Portable electronic device 150 may use the connection to LAN 138 to communicate with transit server 142 or ticket vending machine 116 to purchase a transit product and/or to communicate with access control point 118 to gain access to transit vehicle 102. As shown in the illustrated embodiment, access control point 118 may correspond to an entrance to transit vehicle 102.

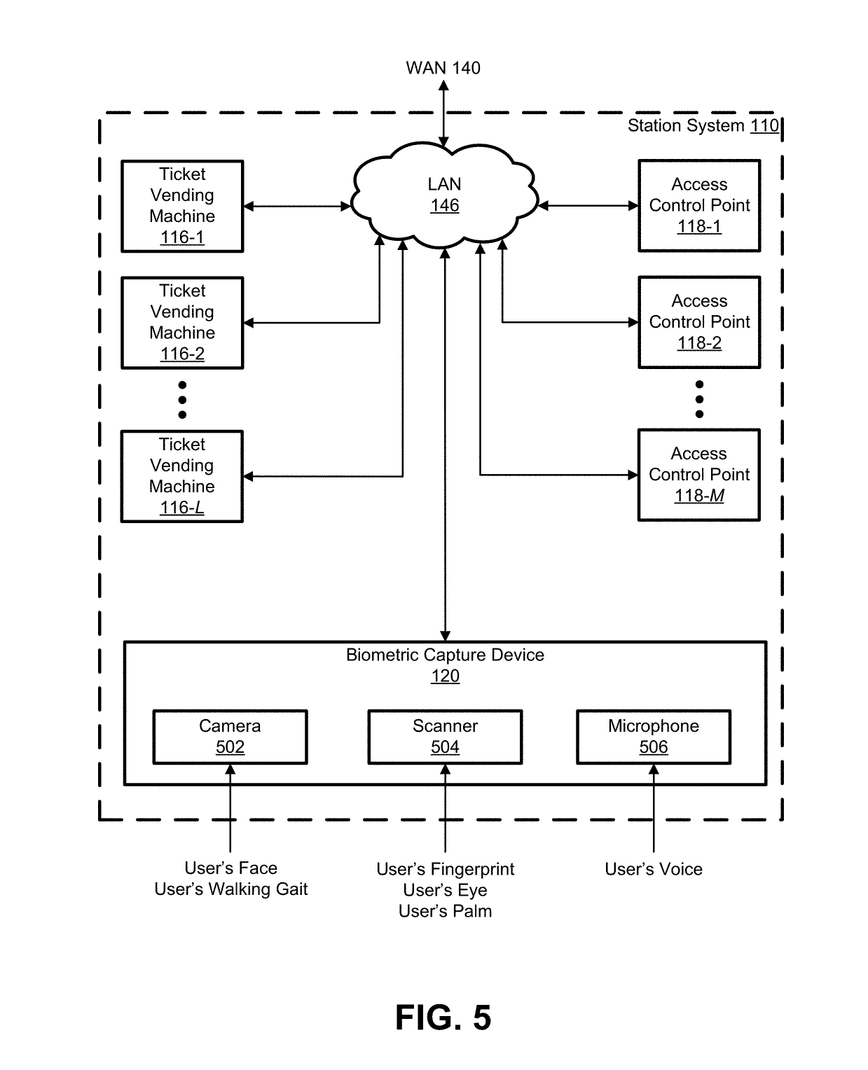

FIG. 5 illustrates a block diagram of station system 110 including a biometric capture device 120, according to some embodiments of the present invention. Although the illustrated embodiment provides a single biometric capture device 120, multiple devices may be provided within station system 110. Biometric capture device 120 may be configured to capture (i.e., detect, measure) a wide variety of biometrics of a transit user. For example, biometric capture device 120 may include a camera 502 configured to capture an image or video of a transit user's face or walking gait. As another example, biometric capture device 120 may include a scanner 504 for scanning a transit user's fingerprint, eye, or palm. As another example, biometric capture device 120 may include a microphone 506 for recording an audio signal of a transit user's voice. Other possibilities of biometrics that may be captured using biometric capture device 120 will be readily apparent to those skilled in the art.

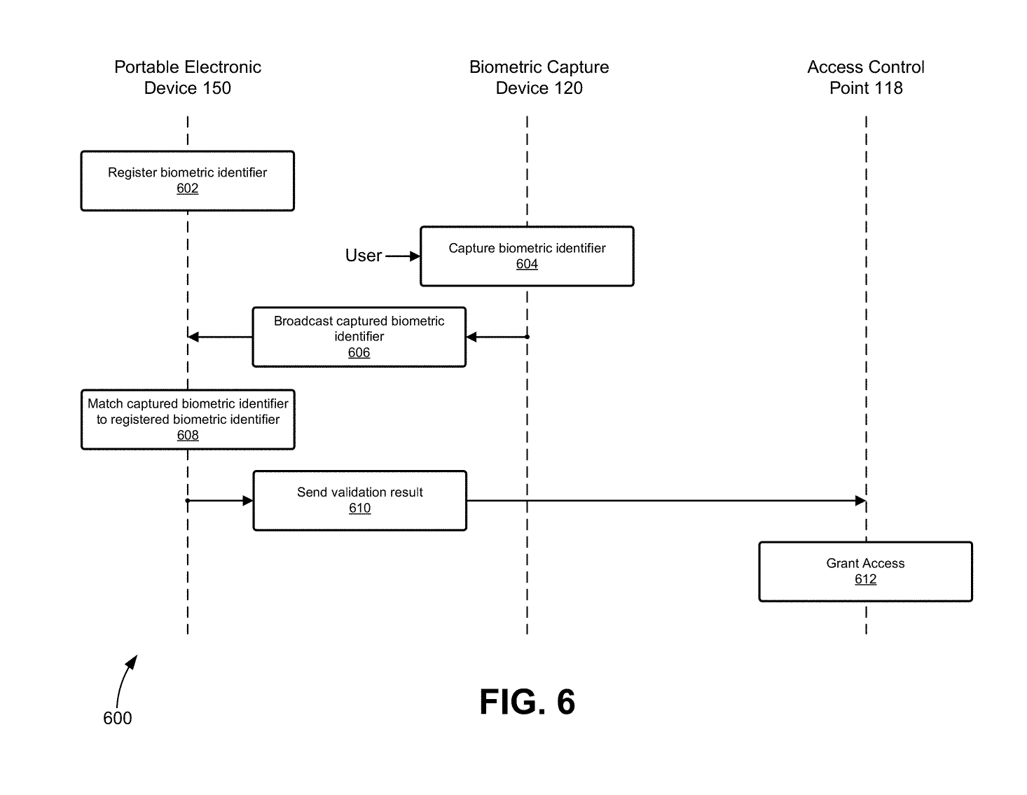

FIG. 6 illustrates a method 600 of validating a biometric token within transit system 100, accordingly to some embodiments of the present invention. One or more steps of method 600 may be performed by portable electronic device 150 and one or more steps of method 600 may be performed by components of transit system 100 such as biometric capture device 120 and access control point 118. Steps of method 600 may be performed in an order different than the illustrated embodiment, and one or more steps of method 600 may be omitted.

At step 602, a biometric identifier is registered by portable electronic device 150. The biometric identifier may include one or more of: an image of the transit user, a video of a walking gait of the transit user, a fingerprint scan of the transit user, an eye scan of the transit user, a palm scan of the transit user, and a voice recording of the transit user. Registering the biometric identifier may include capturing the biometric identifier using the hardware of portable electronic device 150, e.g., taking a picture of the transit user's face using the camera of a mobile phone, saving the biometric identifier to the memory of portable electronic device 150, and linking the stored biometric identifier to a mobile application operating on portable electronic device 150 such that the registered biometric identifier may be retrieved by the mobile application when the mobile application is operating on portable electronic device 150. The mobile application may be downloaded from transit server 142 or from an mobile application source. For example, the transit user can use portable electronic device 150 to download the mobile application from an application store or website provided by a mobile carrier or the hardware and/or software provider of portable electronic device 150.

Upon registering the biometric identifier, the mobile application may be configured such that, when the mobile application is operating on portable electronic device 150, portable electronic device 150 is disabled from transmitting the registered biometric identifier. Furthermore, the mobile application may be configured such that outgoing communications of portable electronic device 150 in relation to operating the mobile application are limited to sending a registration notification to transit system 100 (as described in reference to step 702) and sending a validation result (as described in reference to step 610). In some embodiments, the biometric identifier may only be registered using hardware of portable electronic device 150 (e.g., camera, microphone, etc.) such that the biometric identifier may not be received by portable electronic device 150 and then subsequently linked to the mobile application. Prior to registering the biometric identifier, the mobile application may also determine whether the linked biometric identifier was captured using the hardware of portable electronic device 150. Alternatively or additionally, the mobile application may control the hardware of portable electronic device 150 to capture the biometric identifier (e.g., the mobile application may ask the transit user whether it may access the microphone of portable electronic device 150 to record the transit user's voice).

At step 604, a biometric identifier is captured by biometric capture device 120. The captured biometric identifier may be automatically captured upon the transit user approaching biometric capture device 120 or manually captured by the transit user causing activation of biometric capture device 120 by, for example, pressing a button on biometric capture device 120 or using the mobile application to interact with biometric capture device 120. In some embodiments, biometric capture device 120 may be coupled to a display or a speaker that visually and/or audibly informs the transit user whether the biometric identifier was successfully captured. For example, biometric capture device 120 may attempt to capture an image of the transit user's face. After capturing an image, one or more processors of transit system 100 may analyze the image to determine whether the image contains enough features of the transit user's face or whether the clarity and/or color of the image is within acceptable ranges. Upon determining that the captured image is acceptable, a speaker coupled to biometric capture device 120 may output an audio queue informing the transit user that the biometric identifier was successfully captured.

At step 606, a wireless signal containing the captured biometric identifier is broadcasted by biometric capture device 120, i.e., using an antenna coupled to biometric capture device 120. The wireless signal may be broadcasted periodically, intermittently, or upon user request. In some embodiments, biometric capture device 120 includes one or more processors and a transmitter configured to wirelessly transit the wireless signal. For example, biometric capture device 120 may be a stand-alone system (e.g., a kiosk) located at a transit location at which the transit user may have their biometric identifier captured and subsequently broadcasted from the stand-alone system. In other embodiments, or in the same embodiments, the wireless signal may be broadcasted by a transmitter of transit system 100 coupled to biometric capture device 120. For example, biometric capture device 120 may be mounted to a transit gate (e.g., access control point 118) and may send the captured biometric identifier via a wired connection to a wireless transmitter within the transit gate.

The broadcasted wireless signal may be received by portable electronic device 150 as well as by other devices in the area. In some embodiments, the mobile application may control the hardware of portable electronic device 150 to receive the wireless signal. Accordingly, any device running the mobile application may receive a plurality of wireless signals each containing a different captured biometric identifier. In some embodiments, the mobile application may disable the ability of portable electronic device 150 to receive the wireless signal until the mobile application determines that the transit user has purchased or will purchase a transit product. For example, the mobile application may access the transit user's account to determine whether there is sufficient funds to purchase a transit product. Upon determining that sufficient funds exist, the mobile application may enable portable electronic device 150 to receive the wireless signal containing the captured biometric identifier (as well as other wireless signals containing other captured biometric identifiers). In one example embodiment, the wireless signal may be broadcasted (i.e., transmitted) every second for ten seconds after the biometric identifier is captured. In another example embodiment, the wireless signal is broadcasted a single time after the biometric identifier is captured. Other possibilities are contemplated.

At step 608, the mobile application matches the captured biometric identifier to the registered biometric identifier. Matching may be performed by comparing each received captured biometric identifier to the registered biometric identifier, calculating a similarity score for each comparison, and determining whether any of the calculated similarity scores exceeds a predetermined threshold. The captured biometric identifier having a calculated similarity score that exceeds the predetermined threshold is considered to be matched to the registered biometric identifier. Captured biometric identifiers having calculated similarity scores below the predetermined threshold are not considered to be matched to the registered biometric identifier and are immediately deleted by the mobile application.

At step 610, a validation result indicating whether the captured biometric identifier was matched to the registered biometric identifier is sent (i.e., a wireless signal containing the validation result is sent) to access control point 118 of transit system 100. In some instances, the validation result may only be sent when it indicates a successful match. In other embodiments, the validation result may be sent whether or not the validation result indicates a successful match. In some embodiments, the validation result may include the transit user's name or other information identifying the transit user or the transit user account, thereby allowing transit system 100 to access account information associated with the transit user. The information identifying the transit user may also be used so that access control point 118 may later identify the transit user.

In some embodiments, the validation result is sent to access control point 118 upon the transit user approaching or passing through access control point 118. In one example, portable electronic device 150 may periodically broadcast the validation result as the transit user is passing through access control point 118. In other embodiments, or in the same embodiments, upon arriving at access control point 118 the transit user may cause portable electronic device 150 (e.g., by pressing a button) to send the validation result to access control point 118. For example, the mobile application may ask the transit user when he/she is within range (e.g., within a few feet) of access control point 118 so that the validation result may be sent to access control point 118. In some embodiments, portable electronic device 150 may send the validation result to transit system 100 immediately upon matching the captured biometric identifier to the registered biometric identifier, and thereafter the transit user may be tracked by one or more cameras of transit system 100 positioned within a transit location until the transit user arrives at access control point 118.

At step 612, the transit user carrying portable electronic device 150 is granted access to the restricted access area of transit system 100 based on the validation result. Step 612 may include the steps of accessing the transit user's account and withdrawing funds equal to a fare and/or determining whether sufficient funds are available. Granting access to the transit user may include removing a physical barrier associated with access control point 118, allowing a physical barrier associated with access control point 118 to be moved by the transit user, causing an visual or audible alarm to not trigger, and/or causing a visual or audible message indicating that access is granted to be outputted by one or more devices on or near access control point 118. In some embodiments, granting access to the transit user may include issuing a paper ticket to the transit user or providing the transit user with an access code. Other possibilities are contemplated.

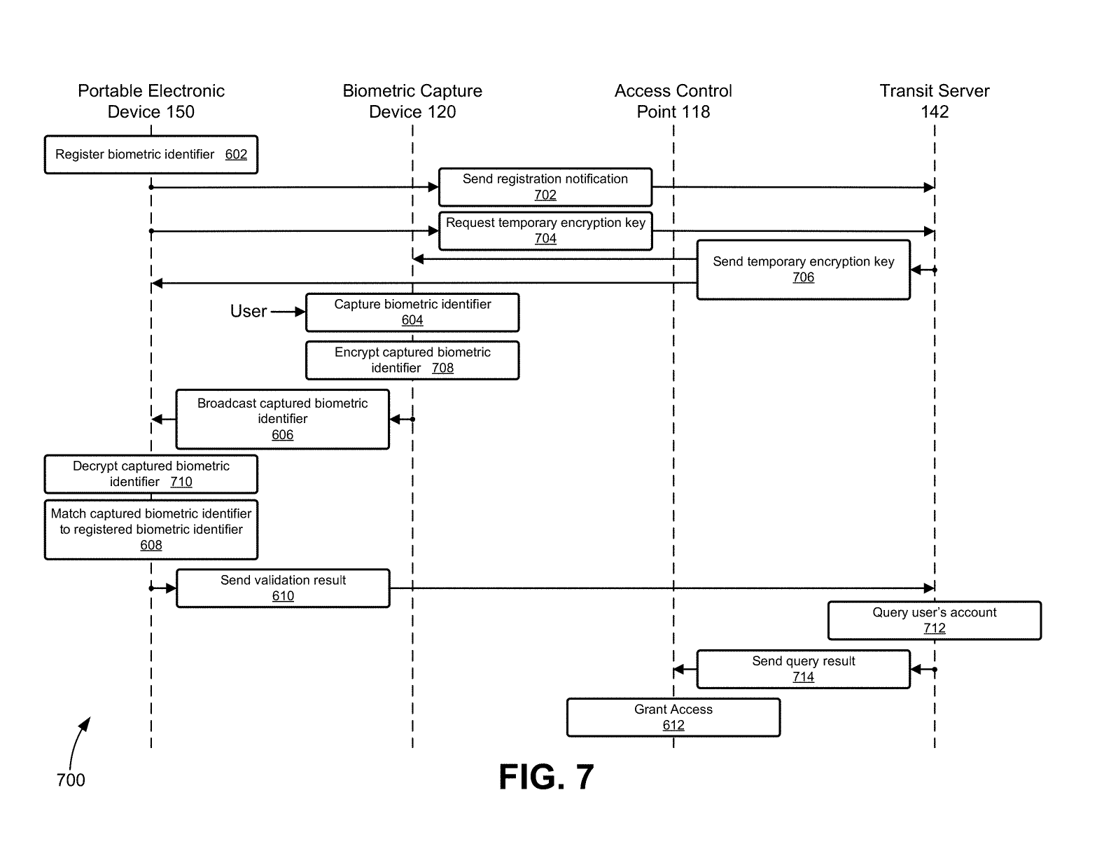

FIG. 7 illustrates a method 700 of validating a biometric token within transit system 100 using data encryption, accordingly to some embodiments of the present invention. Method 700 provides further security over method 600 at the cost of increased system complexity and sophistication. One or more steps of method 700 may be performed by portable electronic device 150 and one or more steps of method 700 may be performed by components of transit system 100 such as biometric capture device 120, access control point 118, and transit server 142. Steps of method 700 may be performed in an order different than the illustrated embodiment, and one or more steps of method 700 may be omitted.

At step 702, a registration notification is sent (i.e., a wireless signal containing the registration notification is sent) by portable electronic device 150 to transit server 142. The registration notification may be sent over cellular network 148 or over LAN 146. The registration notification may indicate that a biometric identifier was successfully registered by portable electronic device 150. In some embodiments, the registration notification may include the transit user's name or other information identifying the transit user or the transit user account, thereby allowing transit system 100 to access account information associated with the transit user. Upon receiving the registration notification, transit server 142 may add the transit user to a list of potential transit users of transit system 100.

At step 704, a request for an encryption key is sent (i.e., a wireless signal containing the request for the encryption key is sent) by portable electronic device 150 to transit server 142. The request may be sent over cellular network 148 or over LAN 146. In some embodiments, step 704 may be performed in conjunction with step 702. For example, by receiving the registration notification, transit server 142 can imply a request by portable electronic device 150 for an encryption key. Similarly, by receiving a request for an encryption key, transit server 142 can imply a registration notification by portable electronic device 150. The encryption key may be a temporary encryption key or an encryption key having a longer period of use. The encryption key may be operable on the captured biometric identifier such that the captured biometric identifier can become encrypted or decrypted using the same encryption key.

At step 706, the encryption key is sent (i.e., a wireless signal containing the encryption key is sent) by transit server 142 to biometric capture device 120 and portable electronic device 150. In some embodiments, the biometric capture device 120 may receive the encryption key from transit server 142 over a wired connection. Portable electronic device 150 may replace a previous encryption key with the received encryption key.

At step 708, the captured biometric identifier is encrypted by biometric capture device 120 using the encryption key received by biometric capture device 120 from transit server 142. Encryption of the captured biometric identifier using the encryption key causes the captured biometric identifier to become unreadable until it is decrypted using the same encryption key.

At step 710, the (encrypted) captured biometric identifier is decrypted by portable electronic device 150 using the encryption key received by portable electronic device 150 from transit server 142. Decryption of the encrypted captured biometric identifier using the encryption key causes the captured biometric identifier to become readable and usable by portable electronic device 150.

At step 712, the transit user's account is queried by transit server 142. In some embodiments, querying the transit user's account may include accessing the transit user's account and withdrawing funds equal to a fare and/or determining whether sufficient funds are available. At step 714, a query result corresponding to the query performed in step 712 is sent from transit server 142 to access control point 118.

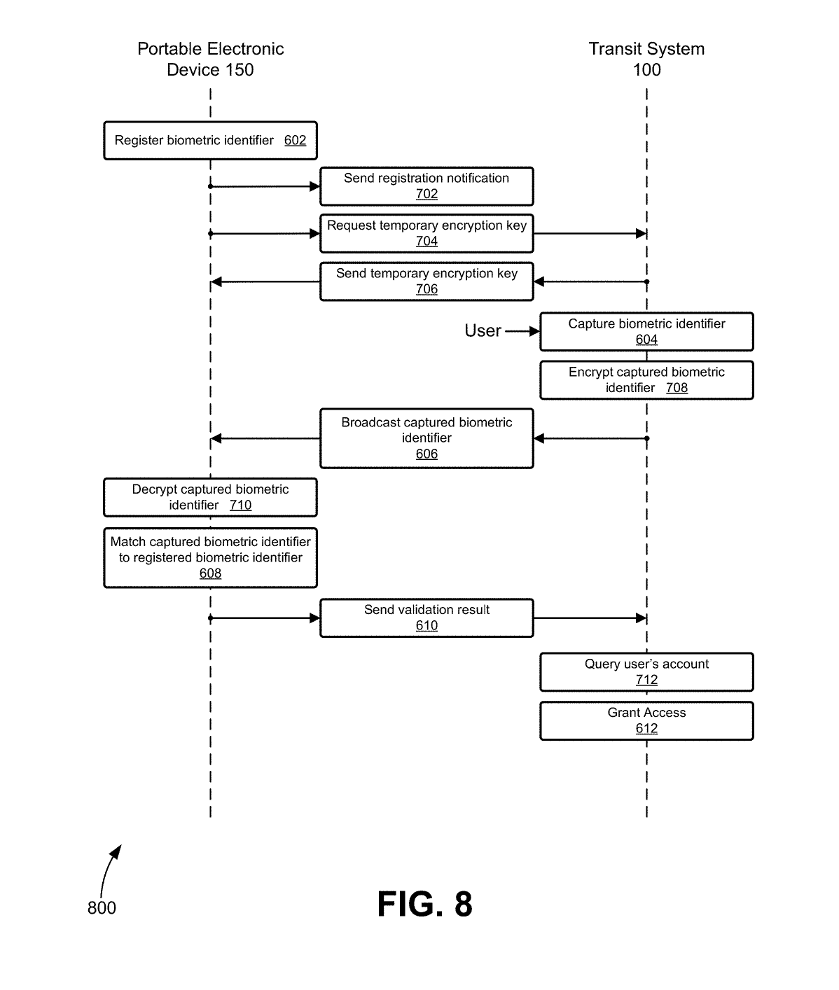

FIG. 8 illustrates a method 800 of validating a biometric token within transit system 100 using data encryption, according to some embodiments of the present invention. Method 800 corresponds to method 700 generalized to transit system 100, which may include biometric capture device 120, access control point 118, and transit server 142. Steps of method 800 may be performed in an order different than the illustrated embodiment, and one or more steps of method 800 may be omitted.

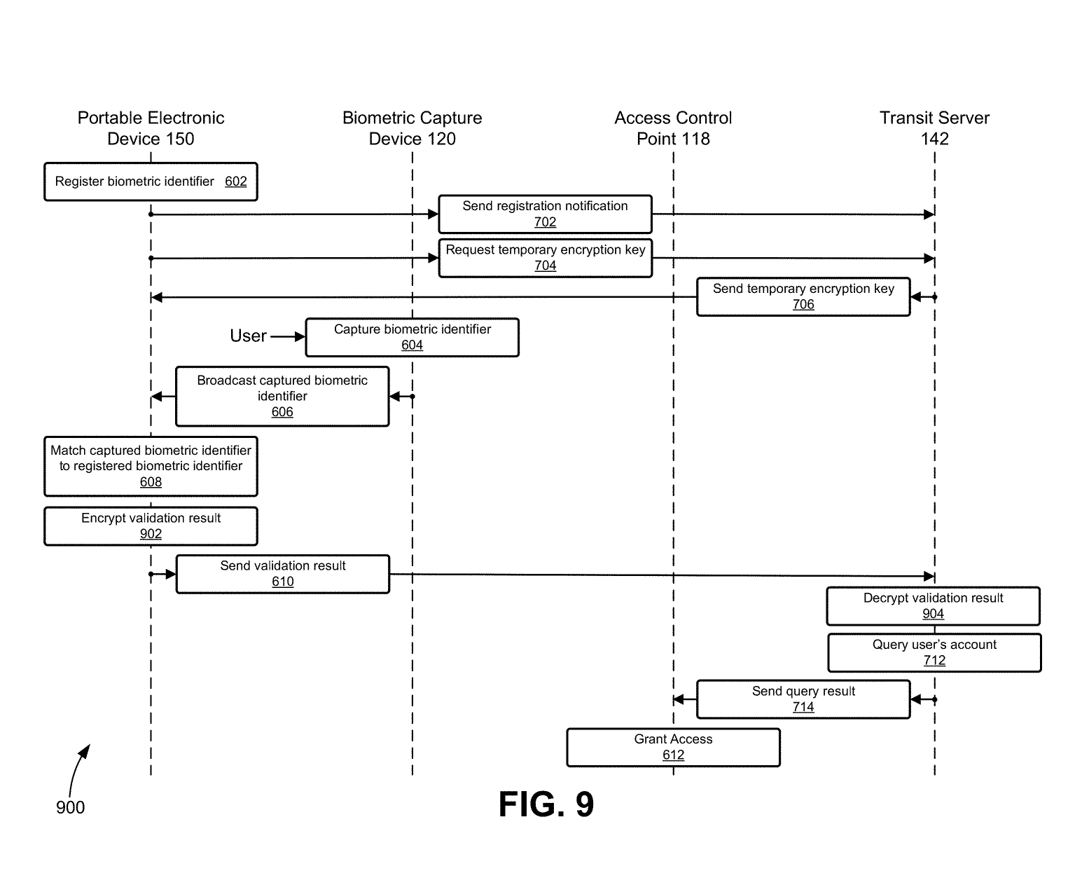

FIG. 9 illustrates a method 900 of validating a biometric token within transit system 100 using data encryption, according to some embodiments of the present invention. One or more steps of method 900 may be performed by portable electronic device 150 and one or more steps of method 900 may be performed by components of transit system 100 such as biometric capture device 120, access control point 118, and transit server 142. Steps of method 900 may be performed in an order different than the illustrated embodiment, and one or more steps of method 900 may be omitted. One or more steps described in reference to method 900 may be used in method 700, and one or more steps described in reference to method 700 may be used in method 900. Step 706 of method 900 may differ from step 706 of method 700 in that the encryption key may be send to portable electronic device 150 but not biometric capture device 120. In some embodiments, the encryption key described in reference to method 900 is different than the encryption key described in reference to method 700. In other embodiments, methods 700 and 900 use the same encryption key.

At step 902, the validation result is encrypted by portable electronic device 150 using the encryption key. The encryption key may be operable on the validation result such that the validation result can become encrypted or decrypted using the same encryption key. Encryption of the validation result using the encryption key causes the validation result to become unreadable until it is decrypted using the same encryption key. At step 904, the (encrypted) validation result is decrypted by transit server 142 using the encryption key (e.g., a copy of the encryption key used in step 902). Decryption of the encrypted validation result using the encryption key causes the validation result to become readable and usable by transit server 142.

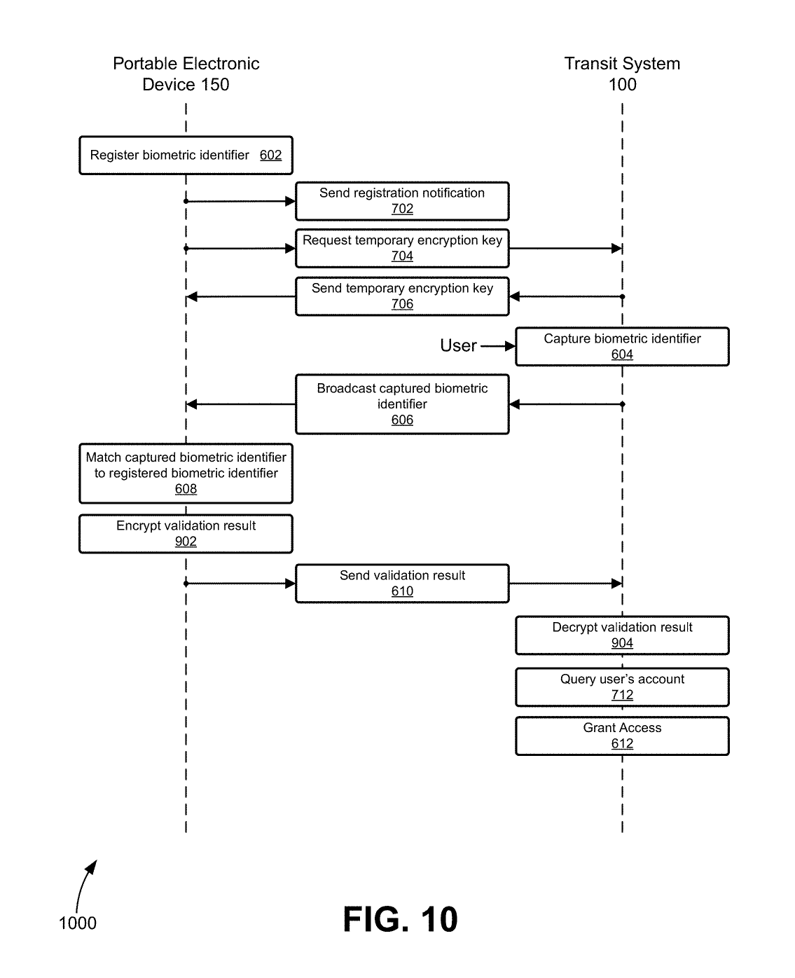

FIG. 10 illustrates a method 1000 of validating a biometric token within transit system 100 using data encryption, according to some embodiments of the present invention. Method 1000 corresponds to method 900 generalized to transit system 100, which may include biometric capture device 120, access control point 118, and transit server 142. Steps of method 1000 may be performed in an order different than the illustrated embodiment, and one or more steps of method 1000 may be omitted.

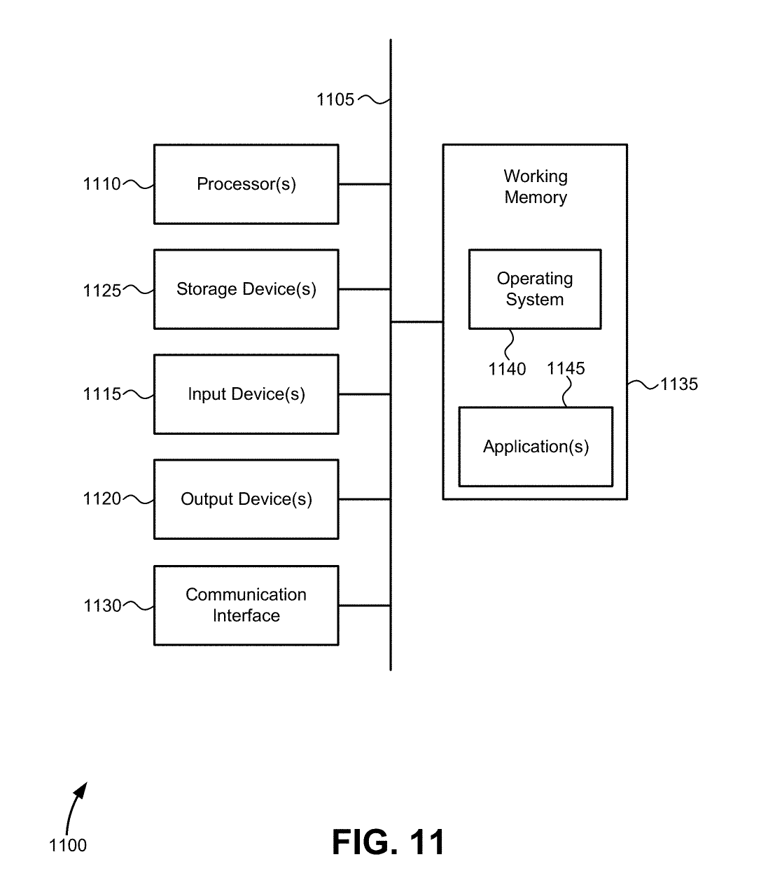

FIG. 11 illustrates a simplified computer system 1100, according to some embodiments of the present invention. Computer system 1100 may be incorporated as part of the previously described computerized devices. For example, computer system 1100 can represent some of the components of transit server 142, ticket vending machine 116, access control point 118, portable electronic device 150, biometric capture device 120, and the like. FIG. 11 provides a schematic illustration of one embodiment of a computer system 1100 that can perform the methods provided by various other embodiments, as described herein. FIG. 11 is meant only to provide a generalized illustration of various components, any or all of which may be utilized as appropriate. FIG. 11, therefore, broadly illustrates how individual system elements may be implemented in a relatively separated or relatively more integrated manner.

The computer system 1100 is shown comprising hardware elements that can be electrically coupled via a bus 1105 (or may otherwise be in communication, as appropriate). The hardware elements may include a processing unit 1110, including without limitation one or more general-purpose processors and/or one or more special-purpose processors (such as digital signal processing chips, graphics acceleration processors, and/or the like); one or more input devices 1115, which can include without limitation a keyboard, a touchscreen, receiver, a motion sensor, a camera, a smartcard reader, a contactless media reader, and/or the like; and one or more output devices 1120, which can include without limitation a display device, a speaker, a printer, a writing module, and/or the like.

The computer system 1100 may further include (and/or be in communication with) one or more non-transitory storage devices 1125, which can comprise, without limitation, local and/or network accessible storage, and/or can include, without limitation, a disk drive, a drive array, an optical storage device, a solid-state storage device such as a random access memory (“RAM”) and/or a read-only memory (“ROM”), which can be programmable, flash-updateable and/or the like. Such storage devices may be configured to implement any appropriate data stores, including without limitation, various file systems, database structures, and/or the like.

The computer system 1100 might also include a communication interface 1130, which can include without limitation a modem, a network card (wireless or wired), an infrared communication device, a wireless communication device and/or chipset (such as a Bluetooth™ device, an 802.11 device, a Wi-Fi device, a WiMax device, an NFC device, cellular communication facilities, etc.), and/or similar communication interfaces. The communication interface 1130 may permit data to be exchanged with a network (such as the network described below, to name one example), other computer systems, and/or any other devices described herein. In many embodiments, the computer system 1100 will further comprise a non-transitory working memory 1135, which can include a RAM or ROM device, as described above.

The computer system 1100 also can comprise software elements, shown as being currently located within the working memory 1135, including an operating system 1140, device drivers, executable libraries, and/or other code, such as one or more application programs 1145, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such special/specific purpose code and/or instructions can be used to configure and/or adapt a general purpose computer (or other device) to a special purpose computer that is configured to perform one or more operations in accordance with the described methods.

A set of these instructions and/or code might be stored on a computer-readable storage medium, such as the storage device(s) 1125 described above. In some cases, the storage medium might be incorporated within a computer system, such as computer system 1100. In other embodiments, the storage medium might be separate from a computer system (e.g., a removable medium, such as a compact disc), and/or provided in an installation package, such that the storage medium can be used to program, configure and/or adapt a general purpose computer with the instructions/code stored thereon. These instructions might take the form of executable code, which is executable by the computer system 1100 and/or might take the form of source and/or installable code, which, upon compilation and/or installation on the computer system 1100 (e.g., using any of a variety of generally available compilers, installation programs, compression/decompression utilities, etc.) then takes the form of executable code.

Substantial variations may be made in accordance with specific requirements. For example, customized hardware might also be used, and/or particular elements might be implemented in hardware, software (including portable software, such as applets, etc.), or both. Moreover, hardware and/or software components that provide certain functionality can comprise a dedicated system (having specialized components) or may be part of a more generic system. For example, a risk management engine configured to provide some or all of the features described herein relating to the risk profiling and/or distribution can comprise hardware and/or software that is specialized (e.g., an application-specific integrated circuit (ASIC), a software method, etc.) or generic (e.g., processing unit 1110, applications 1145, etc.) Further, connection to other computing devices such as network input/output devices may be employed.

Some embodiments may employ a computer system (such as the computer system 1100) to perform methods in accordance with the disclosure. For example, some or all of the procedures of the described methods may be performed by the computer system 1100 in response to processing unit 1110 executing one or more sequences of one or more instructions (which might be incorporated into the operating system 1140 and/or other code, such as an application program 1145) contained in the working memory 1135. Such instructions may be read into the working memory 1135 from another computer-readable medium, such as one or more of the storage device(s) 1125. Merely by way of example, execution of the sequences of instructions contained in the working memory 1135 might cause the processing unit 1110 to perform one or more procedures of the methods described herein.

The terms “machine-readable medium” and “computer-readable medium,” as used herein, refer to any medium that participates in providing data that causes a machine to operate in a specific fashion. In an embodiment implemented using the computer system 1100, various computer-readable media might be involved in providing instructions/code to processing unit 1110 for execution and/or might be used to store and/or carry such instructions/code (e.g., as signals). In many implementations, a computer-readable medium is a physical and/or tangible storage medium. Such a medium may take many forms, including but not limited to, non-volatile media, volatile media, and transmission media. Non-volatile media include, for example, optical and/or magnetic disks, such as the storage device(s) 1125. Volatile media include, without limitation, dynamic memory, such as the working memory 1135. Transmission media include, without limitation, coaxial cables, copper wire and fiber optics, including the wires that comprise the bus 1105, as well as the various components of the communication interface 1130 (and/or the media by which the communication interface 1130 provides communication with other devices). Hence, transmission media can also take the form of waves (including without limitation radio, acoustic and/or light waves, such as those generated during radio-wave and infrared data communications).

Common forms of physical and/or tangible computer-readable media include, for example, a magnetic medium, optical medium, or any other physical medium with patterns of holes, a RAM, a PROM, EPROM, a FLASH-EPROM, any other memory chip or cartridge, a carrier wave as described hereinafter, or any other medium from which a computer can read instructions and/or code.

The communication interface 1130 (and/or components thereof) generally will receive the signals, and the bus 1105 then might carry the signals (and/or the data, instructions, etc. carried by the signals) to the working memory 1135, from which the processor(s) 1105 retrieves and executes the instructions. The instructions received by the working memory 1135 may optionally be stored on a non-transitory storage device 1125 either before or after execution by the processing unit 1110.

The methods, systems, and devices discussed above are examples. Some embodiments were described as processes depicted as flow diagrams or block diagrams. Although each may describe the operations as a sequential process, many of the operations can be performed in parallel or concurrently. In addition, the order of the operations may be rearranged. A process may have additional steps not included in the figure. Furthermore, embodiments of the methods may be implemented by hardware, software, firmware, middleware, microcode, hardware description languages, or any combination thereof. When implemented in software, firmware, middleware, or microcode, the program code or code segments to perform the associated tasks may be stored in a computer-readable medium such as a storage medium. Processors may perform the associated tasks.

What is claimed is:

1. A method of using data encryption to validate a biometric token within a transit system, the method comprising:
sending, by a transit server of the transit system, an encryption key to each of a biometric capture device and a portable electronic device;
capturing, by the biometric capture device of the transit system, a biometric identifier of a transit user;
encrypting, by the biometric capture device, the captured biometric identifier using the encryption key;
broadcasting, by the transit system, a wireless signal containing the captured biometric identifier, wherein the wireless signal is received by the portable electronic device, and wherein the portable electronic device is configured to decrypt the captured biometric identifier using the encryption key;
receiving, by the transit system from the portable electronic device, a validation result indicating that the captured biometric identifier was matched to a registered biometric identifier by the portable electronic device, wherein the registered biometric identifier was registered by the portable electronic device prior to capturing, by the biometric capture device, the biometric identifier of the transit user; and
granting, by the transit system, the transit user access to a restricted access area of the transit system based on the validation result.

2. The method of claim 1, wherein the captured biometric identifier was matched to the registered biometric identifier by the portable electronic device by determining that a similarity score exceeded a similarity threshold.

3. The method of claim 1, wherein the wireless signal containing the captured biometric identifier is broadcasted without saving a copy of the captured biometric identifier within the transit system.

4. The method of claim 1, wherein the captured biometric identifier of the transit user includes one or more of:
an image of the transit user;
a video of a walking gait of the transit user;
a fingerprint scan of the transit user;
an eye scan of the transit user;
a palm scan of the transit user; and
a voice recording of the transit user.

5. A transit system for validating a biometric token, the transit system comprising:
a biometric capture device configured to perform operations including:
capturing a biometric identifier of a transit user; and
broadcasting a wireless signal containing the captured biometric identifier, wherein the wireless signal is received by a portable electronic device; and
an access control point configured to perform actions including:
receiving, from the portable electronic device, a validation result indicating that the captured biometric identifier was matched to a registered biometric identifier by the portable electronic device, wherein the registered biometric identifier was registered by the portable electronic device prior to capturing, by the biometric capture device, the biometric identifier of the transit user; and
granting the transit user access to a restricted access area of the transit system based on the validation result.

6. The transit system of claim 5, wherein the registered biometric identifier was registered using a mobile application downloaded onto the portable electronic device.

7. The transit system of claim 5, wherein the captured biometric identifier was matched to the registered biometric identifier by the portable electronic device by determining that a similarity score exceeded a similarity threshold.

8. The transit system of claim 5, wherein the wireless signal containing the captured biometric identifier is broadcasted without saving a copy of the captured biometric identifier within the transit system.

9. The transit system of claim 5, wherein the biometric capture device is not communicatively coupled to other components of the transit system.

10. The transit system of claim 5, further comprising:
a transit server configured to send an encryption key to each of the biometric capture device and the portable electronic device, and wherein the operations further include encrypting the captured biometric identifier using the encryption key, wherein, after receiving the captured biometric identifier, the portable electronic device is configured to decrypt the captured biometric identifier using the encryption key.

11. The transit system of claim 5, further comprising:
a transit server configured to receive a notification indicating that the registered biometric identifier was registered by the portable electronic device.

12. The transit system of claim 5, wherein the captured biometric identifier of the transit user includes one or more of:
an image of the transit user;
a video of a walking gait of the transit user;
a fingerprint scan of the transit user;
an eye scan of the transit user;
a palm scan of the transit user; and
a voice recording of the transit user.

13. A method of validating a biometric token within a transit system, the method comprising:
capturing, by a biometric capture device of the transit system, a biometric identifier of a transit user;
broadcasting, by the transit system, a wireless signal containing the captured biometric identifier, wherein the wireless signal is received by a portable electronic device;
receiving, by the transit system from the portable electronic device, a validation result indicating that the captured biometric identifier was matched to a registered biometric identifier by the portable electronic device, wherein the registered biometric identifier was registered by the portable electronic device prior to capturing, by the biometric capture device, the biometric identifier of the transit user; and
granting, by the transit system, the transit user access to a restricted access area of the transit system based on the validation result.

14. The method of claim 13, wherein the registered biometric identifier was registered using a mobile application downloaded onto the portable electronic device.

15. The method of claim 13, wherein the captured biometric identifier was matched to the registered biometric identifier by the portable electronic device by determining that a similarity score exceeded a similarity threshold.

16. The method of claim 13, wherein the wireless signal containing the captured biometric identifier is broadcasted without saving a copy of the captured biometric identifier within the transit system.

17. The method of claim 13, wherein broadcasting, by the transit system, the wireless signal includes broadcasting, by the biometric capture device, the wireless signal, and wherein the biometric capture device is not communicatively coupled to other components of the transit system.

18. The method of claim 13, further comprising:
sending, by a transit server of the transit system, an encryption key to each of the biometric capture device and the portable electronic device; and
prior to broadcasting the wireless signal, encrypting, by the biometric capture device, the captured biometric identifier using the encryption key, wherein, after receiving the captured biometric identifier, the portable electronic device is configured to decrypt the captured biometric identifier using the encryption key.

19. The method of claim 13, further comprising:
prior to capturing the biometric identifier of the transit user, receiving, by a transit server of the transit system from the portable electronic device, a notification indicating that the registered biometric identifier was registered by the portable electronic device.

20. The method of claim 13, wherein the captured biometric identifier of the transit user includes one or more of:
an image of the transit user;
a video of a walking gait of the transit user;
a fingerprint scan of the transit user;
an eye scan of the transit user;
a palm scan of the transit user; and
a voice recording of the transit user.
